(19) United States
(12) Patent Application Publication
(10) Pub. No.: US 2026/0112253 A1
(43) Pub. Date: Apr. 23, 2026

(54) USING APPROVED MAINTENANCE TASK ALARM EVENT RECORDS TO MANAGE DATACENTER ALARMS

(71) Applicant: Hewlett Packard Enterprise Development LP, Spring, TX (US)

(72) Inventor: Debdipta Ghosh, Bangalore (IN)

(21) Appl. No.: 19/039,863

(22) Filed: Jan. 29, 2025

(30) Foreign Application Priority Data
Oct. 17, 2024 (IN) 202411078871

(51) Int. Cl. G08B 13/08; G06Q 10/20; G07C 9/22

(52) U.S. Cl. CPC G08B 13/08; G07C 9/22; G06Q 10/20

(57) ABSTRACT

The technique includes monitoring a secure datacenter, which includes computer platforms. The technique includes, responsive to the monitoring, receiving an alarm that represents a detected event associated with the secure datacenter. The technique includes, responsive to the alarm, determining whether the detected event complies with an approved maintenance task to be performed on a given computer platform. Determining whether the detected event complies with the approved maintenance task includes accessing a record corresponding to the approved maintenance task. The record includes entries corresponding to respective expected events that are associated with the approved maintenance task. Determining whether the detected event complies with the approved maintenance task further includes determining whether the record authorizes the detected event. The technique includes regulating whether the alarm is escalated responsive to the determination of whether the record authorizes the detected event.

### BACKGROUND

A large number (e.g., thousands) of servers may be located in a datacenter. A datacenter provides infrastructures (e.g., an electrical power distribution infrastructure, a networking infrastructure, and a cooling infrastructure) to support the servers. A datacenter may have a number of security controls for purposes of detecting and preventing physical security attacks on the servers. As examples, the security controls may include security barriers, security guard-enforced access entry points, security guard patrols, camera surveillance and access-controlled entry doors.

### BRIEF DESCRIPTION OF THE DRAWINGS

FIG. 1A is a block diagram of a secure datacenter having an alarm monitoring engine that manages alarms using pre-approved maintenance task alarm event records, according to an example implementation.

FIG. 1B is a block diagram of an alarm monitoring infrastructure according to an example implementation.

FIG. 2 depicts an expected alarm event sequence according to an example implementation.

FIG. 3 is a flow diagram depicting a technique to manage a datacenter alarm according to an example implementation.

FIGS. 4A, 4B, 4C, 4D, 4E, 4F, 4G and 4H depict processing of datacenter alarms by an alarm monitoring engine, according to an example implementation.

FIG. 5 is a flow diagram depicting a technique to regulate escalation of a datacenter alarm according to an example implementation.

FIG. 6 is an illustration of hardware processor-readable instructions that are stored on a non-transitory storage medium and, when executed by a hardware processor, cause an alarm monitoring engine to regulate escalation of an observed alarm according to an example implementation.

FIG. 7 is a block diagram of a datacenter that includes an alarm monitoring engine to regulate datacenter alarm escalation, according to an example implementation.

### DETAILED DESCRIPTION

A datacenter may have a security infrastructure to detect and inhibit physical security attacks on the datacenter's servers. As used herein, a “physical security attack” on a server refers to one or multiple actions that are conducted for a nefarious purpose and by a human attacker who has physical, or in-person, access to the server. A physical security attack may attack a server's hardware, software, firmware or a combination of the foregoing.

The datacenter's security infrastructure detects and generates alarms for events (called “alarm-triggering events” or “alarm events” herein) that are indicators of physical security attacks. In examples, an alarm may be a message, email, text, or other notification.

In an example, for purposes of gaining physical access to a server to conduct a physical security attack, a human attacker may remove the server's tamper prevention cover. The removal of the tamper prevention cover corresponds to an alarm event. The server may detect removal of its tamper prevention cover and in response to this detection, generate a tamper prevention cover removal alarm. In other examples, a server may detect power up and power down alarm events (which correspond to the server being powered up and down) and generate corresponding alarms.

Although alarm events are indicators of physical security attacks, not all alarm events are attributable to nefarious activities. In an example, a field technician may be authorized to enter a datacenter and perform a certain authorized maintenance task. In this context, a “maintenance task” refers to a unit of work to repair, replace, remove, add or modify one or multiple components (e.g., firmware, software, and/or one or multiple hardware devices) of a server. A maintenance task may include a collection of sub-tasks, or activities. In an example, an authorized maintenance task may be the replacement of a particular graphics processing unit (GPU) card of a particular server. Activities related to replacing the GPU card may trigger a number of false positive alarms. For example, the datacenter's security infrastructure may generate an alarm when a datacenter access door is opened, and a field technician, although authorized to perform the maintenance task, triggers a false positive alarm when the field technician opens the access door to gain entry into the datacenter. In another example, a false positive alarm is generated when the field technician removes a tamper prevention cover of the server. In another example, a false positive alarm is generated when the field technician powers down the server.

In one approach to sorting out false positive alarms from alarms that correspond to actual physical security attacks, a datacenter's security infrastructure may suppress, or ignore, all alarms when authorized maintenance task work is being performed in the datacenter. However, such an approach may fail to detect physical security attacks. For example, a field technician that is authorized to enter the datacenter and perform an authorized maintenance task on a particular server may participate in one or multiple malevolent activities that are outside of the scope of the authorized maintenance task. In a more specific example, a field technician who is authorized to replace a GPU card X on a server Y may, without authorization and potentially for a nefarious purpose, downgrade firmware on the server Y or replace another component (e.g., a NIC card or a GPU card Z) on the server Y. In another example, a field technician may be authorized to replace the GPU card X on the server Y, but the field technician may replace a component on another server or perform another unauthorized modification to another server. In another example, an attacker who is not authorized to enter the datacenter and does not have credentials to open a datacenter access door, may nevertheless gain entry to the datacenter by closely following (or “tail gating”) another person through a datacenter access door. The attacker may perform malicious activities that coincide with a time frame in which authorized maintenance task work is being performed in the datacenter.

In accordance with example implementations that are described herein, an alarm monitoring engine processes alarms for a datacenter by checking the underlying alarm events against records that describe expected alarm event sequences for corresponding authorized maintenance tasks. As a result of this processing, the alarm monitoring engine determines, for a given alarm, whether the underlying alarm event is expected or unexpected. If the alarm monitoring engine determines that the alarm event is expected, then the alarm monitoring engine suppresses the alarm (e.g., the alarm monitoring engine takes no further action to bring further attention to the alarm). If the alarm monitoring engine determines that the alarm event is unexpected, then the alarm monitoring engine escalates the alarm (e.g. sends a notification to a datacenter administrator or takes one or multiple further actions to bring further attention to the alarm).

More specifically, in accordance with example implementations, a datacenter policy specifies that a maintenance task is to be pre-authorized, or pre-approved, before work for the maintenance task is permitted to begin. A pre-approved maintenance task has a corresponding, or associated, pre-approved maintenance task alarm event record (e.g., a file, a portion of a file or another unit of data). A pre-approved maintenance task alarm event record contains entries (called “alarm event entries” herein) that correspond to respective alarm events that are expected to be observed, or detected, as work for the authorized maintenance task is performed. Moreover, the pre-approved maintenance task alarm event record indicates a time sequence of the alarm event entries and correspondingly indicates an expected time sequence (called an “expected alarm event sequence” herein) for the corresponding alarm events. In accordance with example implementations, each alarm event entry contains data that identifies an alarm category (e.g., an access door entry alarm or a tamper prevention cover removal alarm). Moreover, in accordance with example implementations, each alarm event entry further includes data that allows the alarm monitoring engine to match up, or associate, an observed alarm event to the alarm event entry. The alarm monitoring engine determines whether an alarm event is expected by checking information about the alarm event against the pre-approved maintenance task alarm event records.

In an example, a pre-approved maintenance task is the replacement of a NIC card of a server Z by a particular authorized field technician. The pre-approved maintenance task corresponds to a pre-approved maintenance task alarm event record M. An alarm event entry E of the pre-approved maintenance task alarm event record M includes data that represents a tamper prevention cover removal alarm category, and the alarm event entry E further includes data that represents an identifier (e.g., a serial number) for the server Z. Stated differently, the pre-approved maintenance alarm event record M indicates that as work for the pre-approved maintenance task is being performed, an alarm corresponding to the removal of the tamper prevention cover of server Z is to be expected. Moreover, the pre-approved maintenance task alarm event record M indicates the time order in which the tamper prevention cover removal alarm event is to occur relative to other alarm events that are associated with the pre-approved maintenance task.

Continuing the example, as work for the authorized maintenance task is being performed, the field technician removes a tamper prevention cover of the server Z, which results in the generation of a tamper prevention cover removal alarm. The tamper prevention cover removal alarm contains data that associates the underlying alarm event with the server Z. As described further herein, based on an observed maintenance task work history for the pre-approved maintenance task and an expected alarm event sequence indicated by the pre-approved maintenance task alarm event record M, the alarm monitoring engine associates, or matches, the underlying tamper prevention cover removal alarm event with the alarm event entry E. Therefore, for this example, the alarm monitoring engine determines that the tamper prevention cover removal alarm event is expected, and the alarm monitoring engine suppresses the tamper prevention cover removal alarm.

Among potential advantages, managing datacenter alarms based on pre-approved maintenance task alarm event records accurately detects physical security attacks, regardless of whether or not authorized maintenance task work is being performed in the datacenter. Moreover, unauthorized changes to the datacenter's servers are detected, regardless of whether or not the changes are malevolent in nature.

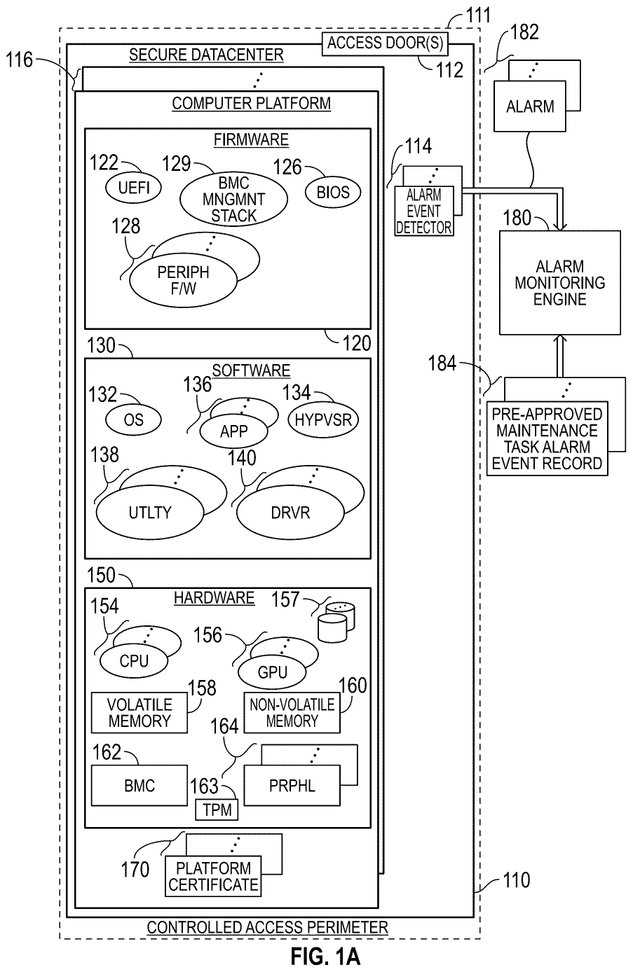

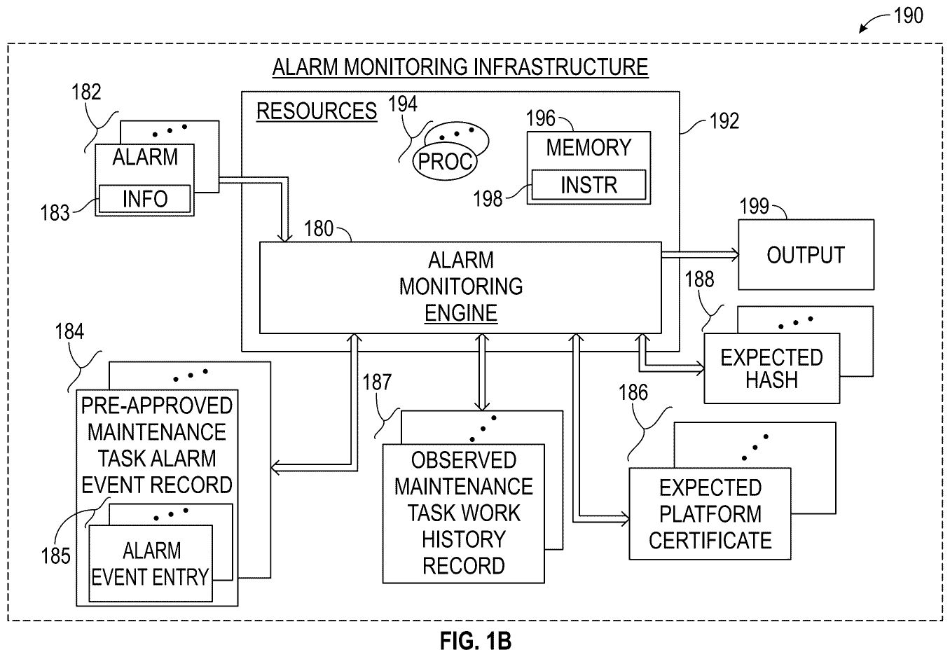

Referring to FIG. 1A, as a more specific example, a secure datacenter 110 includes computer platforms 116. In the context that is used herein, a “computer platform” is a modular unit, which includes a frame, or chassis; and hardware that is mounted to the chassis and is capable of executing machine-readable instructions. In an example, the computer platforms 116 may be servers, such as enclosure-based servers (e.g., blade servers), rack servers (e.g., density line (DL) servers), tower servers or a combination of the foregoing servers. In an example, the secure datacenter 110 may have rows of racks, and multiple computer platforms 116 may be mounted in each rack. In an example, the secure datacenter 110 may have a large number of computer platforms 116, such as hundreds, thousands or even up to millions of computer platforms 116.

An alarm monitoring engine 180 (also referred to an “alarm management engine” herein) processes, or manages, alarms 182 for the secure datacenter 110. The alarms 182 are associated with respective underlying alarm events that are considered to be physical security attack indicators. A given alarm 182 and its associated underlying alarm event may or may not be attributable to a physical security attack. For purposes of accurately classifying the alarms 182 (i.e., sorting alarms 182 corresponding to actual physical security attacks from alarms 182 that do not correspond to physical security attacks), the alarm monitoring engine 180 checks underlying alarm events against pre-approved maintenance task alarm event records 184. More specifically, as further described herein, an alarm event is expected if the alarm event is attributable to pre-approved maintenance task work. Otherwise, the alarm event is unexpected.

As further described herein, using the pre-approved maintenance task alarm event records 184, the alarm monitoring engine 180 sorts out alarms 182 that are attributable to expected alarm events from alarms 182 that are attributable to unexpected alarm events. The alarm monitoring engine 180 suppresses (e.g., updates an observed maintenance task history and then takes no further action) alarms 182 that correspond to expected alarm events, and the alarm monitoring engine 180 escalates (e.g., logs and sends out a message to a datacenter administrator or other appropriate person) alarms 182 that correspond to unexpected alarm events.

The datacenter 110 is considered to be a “secure” due to the datacenter 110 having security controls to inhibit and detect physical security attacks on its computer platforms 116. The alarm monitoring engine 180 is an example of a security control. The secure datacenter 110 has a controlled access perimeter 111, which is another example of a security control. Entry through the controlled access perimeter 111 is regulated through one or multiple access doors 112 of the datacenter 110, which are examples of security controls. In an example, an access door 112 has an associated access control device (e.g. a keypad, a badge reader or a biometric scanner) and a locking operator so that entry through the access door 112 is permitted for authorized credentials (e.g., certain passcodes, certain badge identifiers and certain fingerprints) and not permitted otherwise. In an example, an access door 112 may allow both entry into the secure datacenter 110 and exit from the secure datacenter 110. In another example, a pair of interlocking access doors 112 may be part of an access control vestibule, which includes a physical space between the interlocking access doors 112. The operations of the interlocking access doors 112 are coordinated to allow either a controlled exit from the secure datacenter 110 through one of the interlocking access doors 112 or a controlled entry into the secure datacenter 110 through the other interlocking access door 112. In other examples of security controls, the secure datacenter 110 may include physical security barriers, security guard-enforced access entry points, security guard patrols and camera surveillance.

In another example of security controls, the secure datacenter 110 includes alarm event detectors 114. An alarm event detector 114 detects alarm events that correspond to a particular alarm event type, or category; and the alarm event detector 114 generates alarms 182 for the detected alarm events. In examples, a given alarm event detector 114 may detect and generate alarms 182 for detected alarm events corresponding to one of the following alarm event categories: datacenter access door entry, tamper prevention cover removal, computer platform power down, computer platform power down, computer platform power up, tamper prevention cover open, tamper prevention cover closed, platform certificate mismatch, datacenter access door exit, among other and/or different categories.

As described herein, the alarm event detectors 114 may have a variety of architectures and may be physically situated in a number of locations. In an example, an alarm event detector 114 is located on-board a particular computer platform 116; detects alarm events corresponding to the computer platform 116 and corresponding to a particular alarm event category; and generates alarms 182 in response to detection of these alarm events. In another example, a computer platform 116 may have multiple on-board alarm event detectors 114 that detect alarm events corresponding to multiple alarm event categories. In another example, an alarm event detector 114 is not associated with a particular computer platform 116, but rather, the alarm event detector 114 detects alarm events that are non-computer platform specific but nevertheless are indicators for physical security attacks conducted inside the secure datacenter 110. In an example, an alarm event detector 114 is dedicated to detecting a particular alarm event and generating alarms 182 responsive to detection of these alarm events. In another example, an alarm event detector 114 includes one or multiple components which, in addition to performing alarm-related functions, perform functions unrelated to detecting alarm events or generating alarms 182.

In a more specific example, an alarm event detector 114 is associated with an access door 112. The alarm event detector 114 includes a sensor that detects when the access door 112 opens, and responsive to this detection, the alarm event detector 114 generates an access door open alarm 182. In another example, an alarm event detector 114 detects entry into the secure datacenter 110 through an access door 112, and responsive to this detection, the alarm event detector 114 generates a datacenter access door entry alarm 182. In another example, an alarm event detector 114 detects an exit from the secure datacenter 110 through an access door 112, and responsive to this detection, the alarm event detector 114 generates a datacenter access door exit alarm 182.

In another example, an alarm event detector 114 is associated with a tamper prevention cover of a computer platform 116. In an example, an alarm event detector 114 detects the removal of a computer platform's tamper prevention cover, and responsive to this detection, the alarm event detector 114 generates a tamper prevention cover open alarm 182. In another example, an alarm event detector 114 detects a tamper prevention cover being replaced on a computer platform 116, and responsive to this detection, the alarm event detector 114 generates a tamper prevention cover closed alarm 182.

In another example, an alarm event detector 114 detects motion in a certain area of the secure datacenter 110, and responsive to this detection, the alarm event detector 114 generates a motion detection alarm 182. In another example, an alarm event detector 114 detects, using facial recognition or badge scanning, an unrecognized person in the secure datacenter 110, and responsive to this detection, the alarm event detector 114 generates an unrecognized person alarm 182.

Components for an example computer platform 116-1 are depicted in FIG. 1A. Other computer platforms 116 may have different compositions of components than the computer platform 116-1, and moreover, the architectures of the computer platforms 116 may vary. Regardless of its particular architecture and specific components, a given computer platform 116 includes firmware, software and hardware, such as the depicted firmware 120, software 130 and hardware 150 of the computer platform 116-1.

The hardware 150 of the computer platform 116-1 includes central processing unit (CPU) cores 154 and GPU cores 156. The CPU cores 154 may correspond to one or multiple CPU packages (or “chips”). The GPU cores 156 may correspond to one or multiple GPU packages and may further correspond to one or multiple GPU cards. The hardware 150 further includes one or multiple storage devices 157 (e.g., one or multiple solid-state drives (SSD(s)) and/or one or multiple magnetic storage drives). The hardware 150 further includes volatile memory 158 (e.g., memory that includes memory modules, such as dual inline memory modules (DIMM(s)) and non-volatile memory 160 (e.g., NAND flash devices). The hardware 150 further includes a baseboard management controller (BMC) 162, a trusted platform module (TPM) 163 and one or multiple peripherals 164. In examples, a given peripheral 164 may be a storage device 157, a smart I/O peripheral or a NIC card.

The firmware 120 of the computer platform 116-1 includes system firmware, such as firmware corresponding to a Unified Extensible Firmware Interface (UEFI) 122, a BMC management stack 129 and a Basic Input/Output System (BIOS) 126. In an example, the system firmware may correspond to a firmware image that is stored in the non-volatile memory 160 (e.g., stored in one or multiple NAND flash chips). The firmware 120 may further include units of peripheral firmware 128 (e.g., option card firmware), which are stored in non-volatile memories of respective peripherals 164.

The software 130 of the computer platform 116-1 includes software corresponding to one or multiple operating systems 132, applications 136, one or multiple hypervisors 134, utilities 138, drivers 140, as well as other software components.

In accordance with example implementations, the computer platforms 116 store platform certificates, such as the platform certificates 170 that are depicted for the computer platform 116-1. In this context, a “platform certificate” is a verifiable (e.g., cryptographically signed) security artifact that is bound to a specific computer platform 116 and includes data representing an inventory (e.g., an inventory of hardware components and firmware) of the computer platform 116. In accordance with example implementations, a computer platform 116 may store a base platform certificate and zero, one or multiple delta platform certificates.

A base platform certificate is the first, or initial, platform certificate stored in the computer platform 116 by the computer platform's original equipment manufacturer (OEM). A base platform certificate binds a specific computer platform 116 to a specific inventory of components. In an example, a base platform certificate binds a computer platform 116 to a specific inventory of system firmware, peripheral firmware and hardware components. A base platform certificate may be used to verify that the hardware and firmware of a computer platform 116 has not been altered in the supply chain after the computer platform 116 left the factory. A delta platform certificate is bound to a base platform certificate, is bound to the same computer platform 116 as the base platform certificate, and indicates one or multiple changes to the computer platform's initial inventory (as represented by the base platform certificate).

A base platform certificate in conjunction with the delta platform certificate(s) (if any) may be used to verify that no unauthorized, or unexpected, changes to the hardware and firmware of a computer platform 116 have occurred. In an example, the base and delta platform certificates have profiles that are described in “TCG Platform Certificate Profile,” Specification Version 1.1, Revision 19 (10 Apr. 2020), which is published by the Trusted Computing Group (TCG). In an example, a computer platform 116 may store its platform certificate(s) in a secure processor of the computer platform 116. In an example, the platform certificate(s) 170 for the computer platform 116-1 may be stored in the TPM 163 or in a secure enclave memory of the BMC 162.

In accordance with example implementations, an alarm event detector 114 includes one or multiple components of a computer platform 116, which perform other functions unrelated to detecting alarm events and generating alarms 182. In an example, an alarm event detector 114 includes a BMC, such as the BMC 162 of the computer platform 116-1. In another example, an alarm event detector 114 includes an operating system kernel agent, such as an operating system kernel agent corresponding to the operating system 132 of the computer platform 116-1.

A BMC (e.g., the BMC 162) provides management services for its computer platform 116. As examples of management services, the BMC monitors environmental sensors (e.g., temperature sensors, cooling fan speed sensors); monitors operating system status; monitor power statuses; logs computer system events; provides virtual media management functions; and performs remotely-controlled computer platform functions. A BMC may also provide security services (e.g., cryptographic services) for its computer platform 116.

In addition to providing management services and security services, a BMC may also be associated with one or multiple alarm event detectors 114 for its computer platform 116. In an example, a BMC (e.g., the BMC 162) corresponds to an alarm event detector 114 that detects when the BMC's computer platform 116 (e.g., the computer platform 116-1) powers up, and responsive to this detection, the BMC generates a corresponding computer platform power up alarm 182. In another example, a BMC corresponds to an alarm event detector 114 that detects when the BMC's computer platform 116 powers down, and responsive to this detection, the BMC generates a corresponding computer platform power down alarm 182. The powering up and powering down of a computer platform 116 are considered to be respective alarm events, as these activities are physical security attack indicators.

A computer platform 116, in accordance with example implementations, has a main, or primary, power supply, and the computer platform 116 also has an auxiliary power supply. A BMC of the computer platform 116 is powered by the auxiliary power supply when AC power is available, and the remainder of the computer platform 116 is powered by the primary power supply. This feature allows the BMC to perform “lights out” functions for the computer platform 116 when the primary power supply is turned off. Moreover, due to its separate auxiliary power supply, the BMC is able to detect power up and power down events for the primary power supply, and generate corresponding alarms 182.

In another example, a BMC (e.g., the BMC 162) corresponds to an alarm event detector 114 that detects when a tamper prevention cover of the BMC's computer platform (e.g., the computer platform 116-1) is removed, and responsive to this detection, the BMC generates a corresponding tamper prevention cover open alarm 182. For this purpose, in an example, the BMC 162 monitors a sensor that indicates when the tamper prevention cover is open or closed. In another example, a BMC corresponds to an alarm event detector 114 that detects when a tamper prevention cover of the BMC's computer platform is replaced, and responsive to this detection, the BMC generates a corresponding tamper prevention cover closed alarm 182.

In another example, a BMC (e.g., the BMC 162) corresponds to an alarm event detector 114 that detects when the BMC's computer platform 116 (e.g., the computer platform 116-1) has an unexpected inventory, and responsive to this detection, the BMC generates a platform certificate mismatch alarm 182. More specifically, in accordance with example implementations, a BMC, responsive to the power up of the computer platform's primary power supply, determines an observed inventory of hardware and firmware of the computer platform 116. The BMC further determines whether the inventory is the same as, or matches, an expected inventory that is represented by the computer platform's platform certificate(s). If the observed and expected inventories are not the same, then the BMC generates a platform certificate mismatch alarm 182.

A computer platform's observed inventory differing from its expected inventory is an indicator of physical tampering with the computer platform 116. For example, the discrepancy may be due to unauthorized replacement, addition or modification of firmware and/or hardware of the computer platform 116 while the computer platform was powered off. The discrepancy may alternatively be attributable to an inventory change corresponding to a pre-approved maintenance task.

In another example of a BMC (e.g., the BMC 162) corresponds to an alarm detector 114 that, responsive to a boot of the BMC's computer platform 116 (e.g., the computer platform 116-1), determines whether an observed measurement digest, or hash, for the computer platform 116 matches an expected measurement hash for the computer platform 116. If the observed and expected hashes do not match, then is considered an alarm event, and the BMC generates a hash mismatch alarm 182. In an example, the computer platform 116 undergoes a measured boot in which software and firmware components of the computer platform 116 are loaded and measured in accordance with a boot sequence. The links of a chain of trust for the computer platform 116 are measured during the measured boot, starting with the platform's anchor of trust (e.g., a hardware root of trust), which corresponds to the initial link of the chain of trust. The anchor of trust measures firmware corresponding to the next link of the chain of trust. This firmware is then loaded and measures firmware corresponding to the next of the chain of trust. This loading and measuring continues from one link of the chain of trust to the next and ends with a bootloader for the operating system being measured and then loaded. Each measurement extends platform configuration register (PCR) content of a TPM (e.g., the TPM 163) of the computer platform 116 so that at the conclusion of the measured boot, the PCR content corresponds to an observed measurement hash for the computer platform 116. Due to the nature of hashes, any minute change to the measured firmware or software causes the observed measurement hash to differ from the expected measurement hash.

An observed measurement hash differing from the expected measurement hash is an indicator of physical tampering with a computer platform 116. For example, the discrepancy may be due to unauthorized replacement, addition or modification of software or firmware of the computer platform 116. The discrepancy may alternatively be attributable to a software or firmware change corresponding to a pre-approved maintenance task.

In another example, an attestation verifier corresponds to an alarm event detector 114. The attestation verifier challenges a computer platform 116 and generates a hash mismatch alarm 182 when an observed measurement hash for the computer platform 116 differs from an expected measurement hash for the computer platform 116. In an example, a TPM (e.g., the TPM 163) of a computer platform 116 (e.g., the computer platform 116-1) may, in response to an attestation challenge by the verifier, send a PCR quote to a verifier. The verifier is separate from the computer platform 116, and the PCR quote contains an observed measurement hash for the computer platform 116. The verifier compares the observed measurement hash to an expected measurement hash for the computer platform 116, and if the hashes are not the same, then the verifier generates a hash mismatch alarm 182. In an example, the verifier may be remote with respect to the computer platform 116 (e.g., located in a datacenter other than the secure datacenter 110 or located at a different geographical location than the geographical location of the secure datacenter 110), and as such, this is an example of an alarm event detector 114 that is outside of the secure datacenter 110. In another example, the verifier is located inside the secure datacenter 110 (e.g., the verifier corresponds to a computer platform 116 other than the computer platform 116 being challenged by the verifier).

In another example, an operating system kernel agent (e.g., a kernel agent of the operating system 132) corresponds to an alarm event detector 114. The kernel agent measures files before the operating system executes the files, and the kernel agent compares the observed hashes to expected hashes for the files. The kernel agent generates a hash mismatch alarm 182 if an observed hash is different from an expected hash.

In another example, a hash monitoring engine for the secure datacenter 114 corresponds to an alarm event detector 114. In examples, the hash monitoring engine may be hosted by a computer platform 116 of the secure datacenter 110 or hosted by a remote computer platform outside of the secure datacenter 110. The hash monitoring engine monitors the hashes corresponding to nodes of a Merkle tree (or “hash tree”). Leaf nodes of the Merkle tree correspond to respective observed hashes for respective computer platforms 116. The hash monitoring engine monitors the observed hashes corresponding to ancestor nodes of the Merkle tree for purposes of detecting whether an observed hash differs from the corresponding expected hash. Responsive to detecting a hash mismatch corresponding to an ancestor node of the Merkle tree, the hash monitoring engine may perform any of a number of actions. In an example, the hash monitoring engine may generate hash mismatch alarm(s) 182 for the computer platform(s) 116 that correspond to descendant node(s) of the ancestor node. In another example, the hash monitoring engine may evaluate observed hash(es) of the descendent node(s) for purposes of identifying a particular computer platform 116 having an unexpected hash.

In another example of an alarm event detector 114, a security processor or smart I/O peripheral (also called a “data processing unit,” or “DPU”) of a computer platform 116 compares an observed hash for the computer platform 116 to an expected hash for the computer platform 116, and generates a hash mismatch alarm 182 if the hashes are not the same. In another example, a chassis management controller corresponds to an alarm event detector 114. The chassis management controller and a collection of computer platforms 116 are installed in the same rack. The chassis management controller compares, for each of the computer platforms 116, an observed hash for the computer platform 116 to an expected hash for the computer platform 116, and generates a hash mismatch alarm 182 if the hashes are not the same.

In the context that is used herein, a BMC is a specialized service processor that monitors the physical state of a server or other hardware using sensors and communicates with a management system through a management network. The BMC may also communicate with applications executing at the operating system level through an input/output controller (IOCTL) interface driver, a representational state transfer (REST) application program interface (API), or some other system software proxy that facilitates communication between the BMC and applications. The BMC may have hardware level access to hardware devices that are located in a server chassis including system memory. The BMC may be able to directly modify the hardware devices. The BMC may operate independently of the operating system of the system in which the BMC is disposed. A BMC may be located on the motherboard or main circuit board of the server or other device to be monitored.

The fact that a BMC is mounted on a motherboard of the managed server/hardware or otherwise connected or attached to the managed server/hardware does not prevent the BMC from being considered “separate” from the server/hardware. As used herein, BMC has management capabilities for sub-systems of a computing device, and is separate from a processing resource that executes an operating system of a computing device. The BMC is separate from a processor, such as a central processing unit, which executes a high-level operating system or hypervisor on a system.

In the context that is used herein, a “hash” (which may also be referred to by such terminology as a “digest,” “hash value,” or “hash digest”) is produced by the application of a cryptographic hash algorithm to an input value. A cryptographic hash algorithm receives an input value, and the cryptographic hash algorithm generates a hexadecimal string (the digest, or hash) to match the input value. In an example, the input value may include a string of data (for example, a data structure in memory denoted by a starting memory address and an ending memory address). In such an example, based on the string of data, the cryptographic hash algorithm outputs a hexadecimal string (the digest, or hash). Any minute change to the input value alters the output hexadecimal string. In examples, the cryptographic hash function may be a secure hash algorithm (SHA), a Federal Information Processing Standards (FIPS)-approved hash algorithm, a National Institute of Standards and Technology (NIST)-approved hash algorithm, or any other cryptographic hash algorithm. In some examples, instead of a hexadecimal format, another format may be used for the string.

FIG. 1B depicts an alarm monitoring infrastructure 190 for the secure datacenter 110 in accordance with example implementations. Referring to FIG. 1B, the alarm monitoring engine 180 determines whether an underlying alarm event for a given alarm 182 is expected based on information 183 associated with the alarm 182, observed maintenance task work history records 187 and pre-approved maintenance task alarm event records 184. As described further herein, in processing the alarms 182, the alarm monitoring engine 180 may further consider other information, such expected platform certificates 186 and expected hashes 188.

As a result of processing an alarm 182 and determining whether the underlying alarm event is expected or unexpected, the alarm monitoring engine 180 provides an output 199. The alarm monitoring engine 180 suppresses an alarm 182 that corresponds to an expected alarm event. In an example, the output 199 corresponding to a suppressed alarm 182 is a log entry that records details about the alarm 182 and marks the underlying the alarm event as being expected. The alarm monitoring engine 180 escalates an alarm 182 that corresponds to an unexpected alarm event. In an example, the output 199 corresponding to an escalated alarm 182 includes one or multiple further alarms (e.g., a notification sent to a datacenter administrator). Moreover, in another example, the output 199 corresponding to an escalated alarm 182 may further include a log entry that records details about the alarm 182 and marks the underlying alarm event as being unexpected.

A pre-approved maintenance task alarm event record 184 is associated with, or corresponds to, a particular pre-approved maintenance task. A pre-approved maintenance task alarm event record 184 contains data that represents an expected time sequence (called the “expected alarm event sequence” herein) of alarm events when work is performed on the pre-approved maintenance task.

In an example, an alarm event may directly correspond to an expected operation, activity or action of a pre-approved maintenance task. For example, for a pre-approved maintenance task to replace a GPU card on a computer platform, powering down the computer platform is an expected action associated with work on the pre-approved maintenance task, and powering down the computer platform is expected to trigger a computer platform power down alarm 182.

In another example, an alarm event may indirectly correspond to an expected operation, activity or action of a pre-approved maintenance task. For example, for a pre-approved maintenance task to replace an older version GPU card on a computer platform with a newer version GPU card, it is expected that the replacement occurs while the computer platform is powered down. Continuing this example, the change in inventory of the computer platform causes the computer platform to, when power is restored, generate a platform certificate mismatch alarm 182.

An alarm 182, in accordance with example implementations, is associated with information 183 that describes details about the alarm 182. In an example, an alarm 182 may be a message or notification that contains data representing the information 183. In an example, the information 183 identifies the particular alarm type, or category, of the alarm 182. For example, the information represents that the alarm 182 is a tamper prevention cover open alarm. The information 183 also contains specific details about the underlying alarm event. In an example, for a datacenter access door entry alarm 182, the information 183 contains an identifier for the access door and further contains credentials used by the person to open the access door. In an example, for a datacenter access door entry alarm 182, the information 183 contains an identifier for the access door and further contains credentials used by the person to open the access door. In another example, for a tamper prevention cover open alarm 182, the information 183 contains an identifier for the corresponding computer platform.

A pre-approved maintenance task alarm event record 184, in accordance with example implementations, includes alarm event entries 185 that correspond to respective expected alarm events. Moreover, in accordance with example implementations, the alarm event entries 185 are ordered in the record 184 according to an expected time sequence in which the corresponding expected alarm events are to be observed when work for the pre-approved maintenance task is performed. In accordance with example implementations, an alarm event entry 185 contains data that represents information about the corresponding alarm event. In an example, an alarm event entry 185 identifies an alarm type, or category. In examples, an alarm event entry 185 associates an alarm event with a computer platform power up alarm or associates the alarm event with a tamper prevention cover removal alarm.

In accordance with example implementations, an alarm event entry 185 also contains data that represents information that allows the alarm monitoring engine 180 to match an alarm 182 to the alarm event entry 185. This matching uses the information 183 associated with the alarm 182. For example, for a tamper prevention cover open alarm 182, information 183 associated with the alarm 182 specifies a computer platform identifier XYZ (i.e., the information 183 represents that the tamper prevention cover of computer XYZ was opened), and the corresponding alarm event entry 185 for the corresponding pre-approved maintenance task event record 184 specifies computer platform identifier XYZ.

The observed maintenance task work history records 187 are associated with respective pre-approved maintenance tasks. An observed maintenance task work history record 187 contains data that represents the current state of the associated pre-approved maintenance task. In an example, an observed maintenance task work history record 187 includes data representing the specific alarm events (if any) for the associated pre-approved maintenance task, which have been observed by the alarm monitoring engine 180. In an example, an observed maintenance task work history record 187 reveals no observed alarm events for an associated pre-approved maintenance task for which work has yet to begin. In another example, an observed maintenance task work history record 187 lists a set of observed alarm events for an associated pre-approved maintenance task. In another example, an observed maintenance task work history record 187 indicates that the associated pre-approved maintenance task is complete, as all alarm events have been observed by the alarm monitoring engine 180. The alarm monitoring engine 180, in accordance with example implementations, manages the observed maintenance task work history records 187 to update the states of the pre-approved maintenance tasks as the alarm monitoring engine 180 matches alarms 182 to expected alarm events for the pre-approved maintenance tasks.

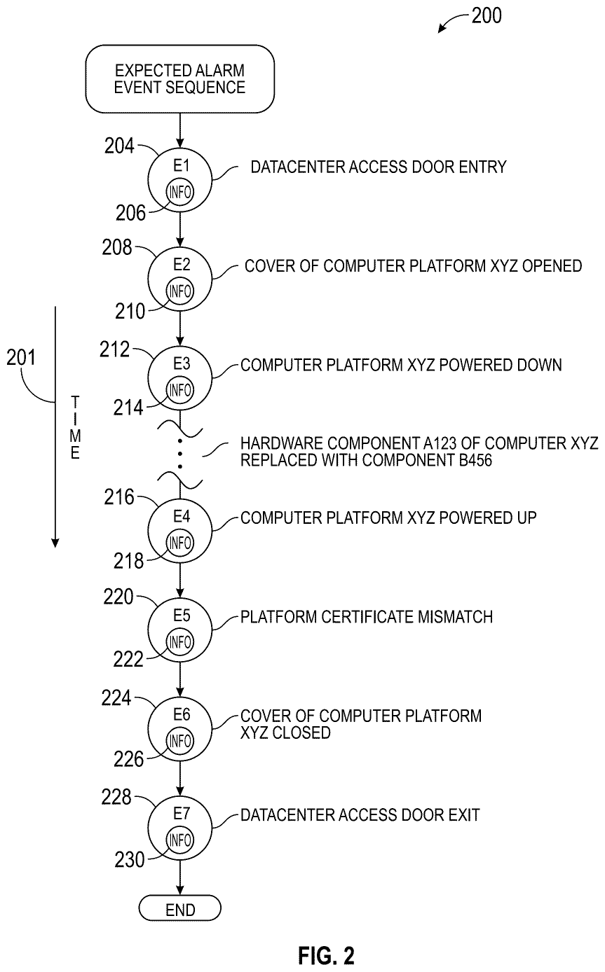

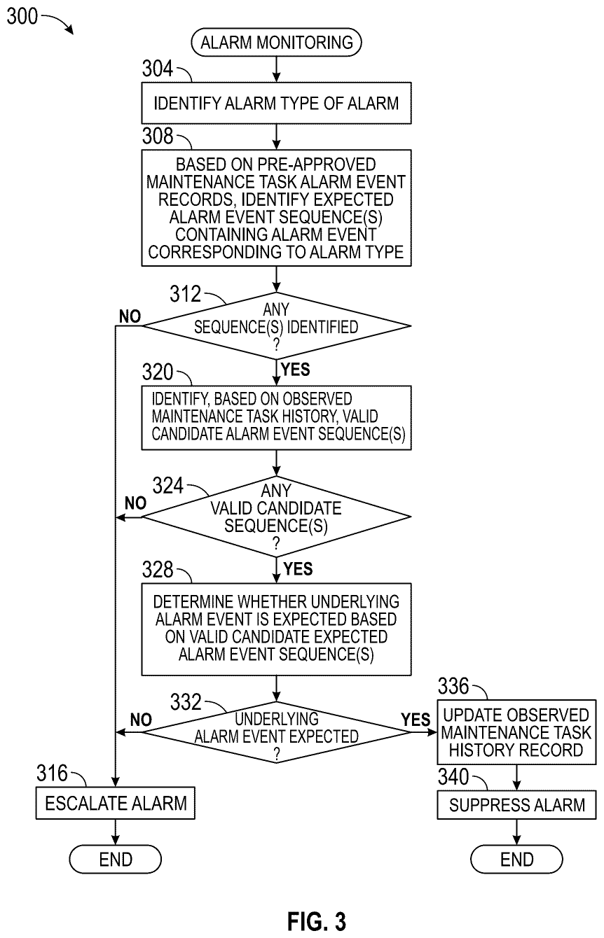

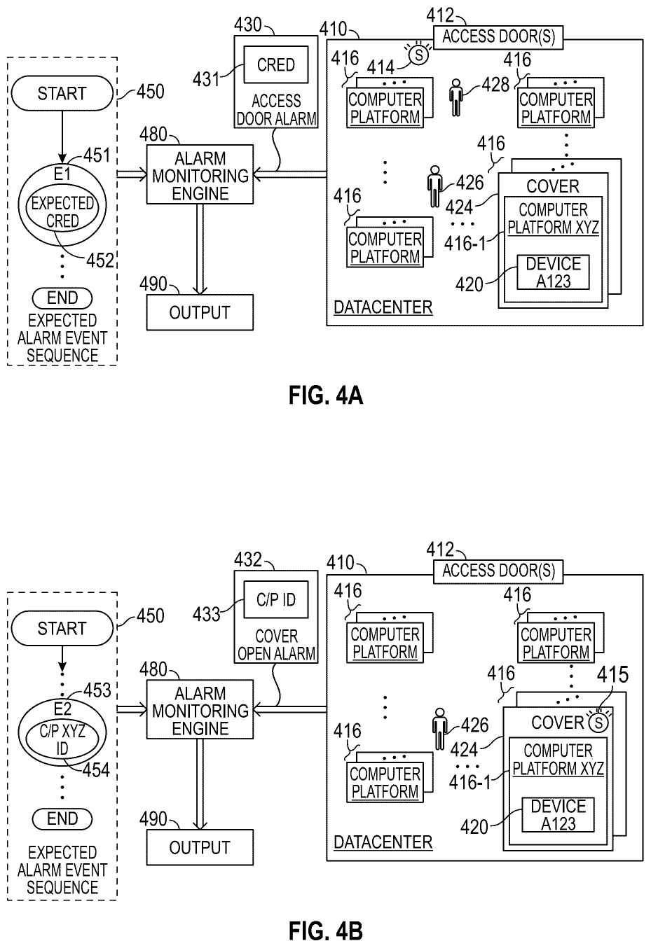

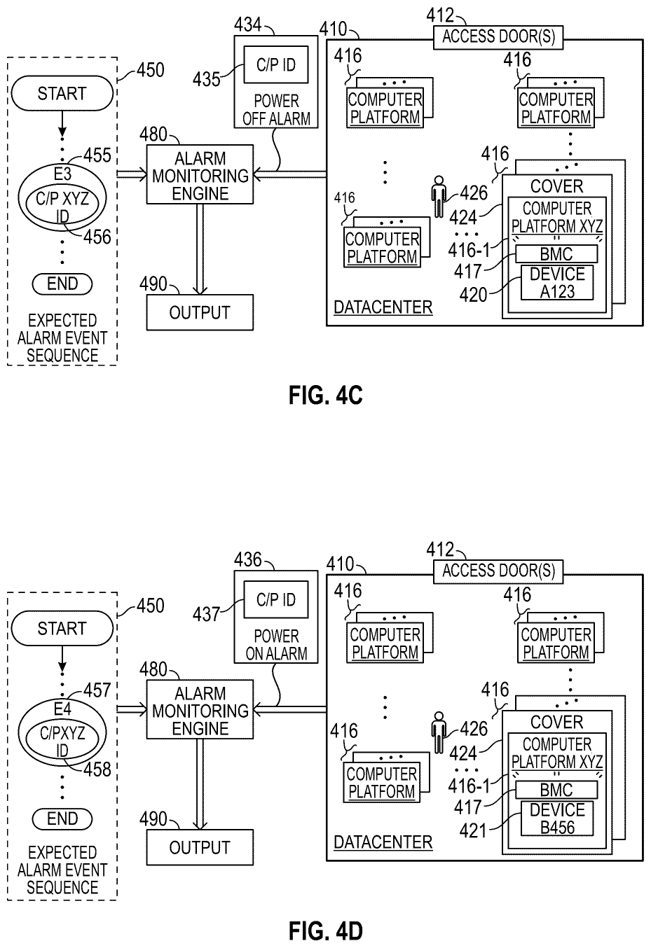

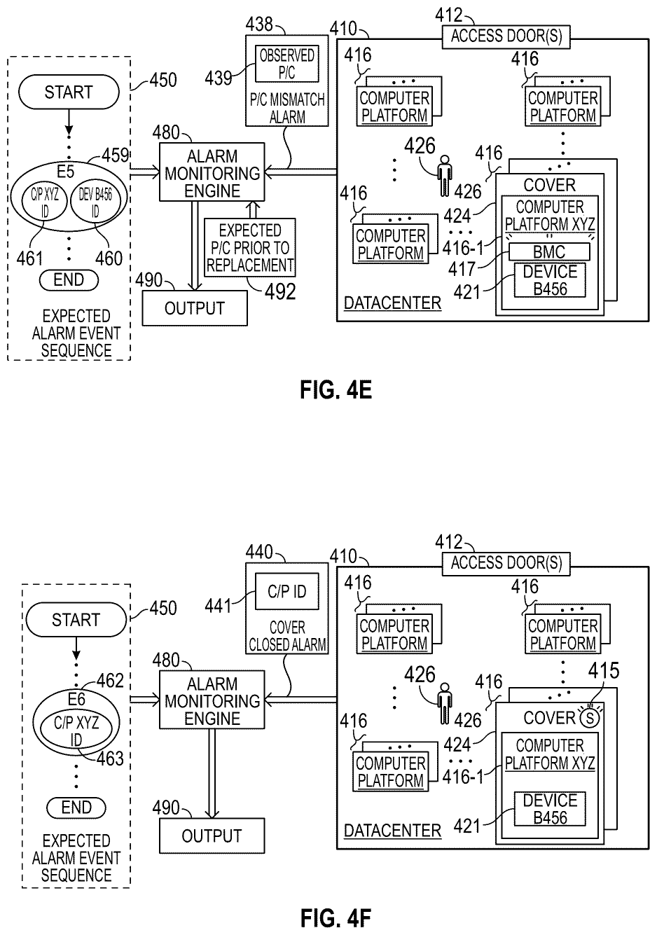

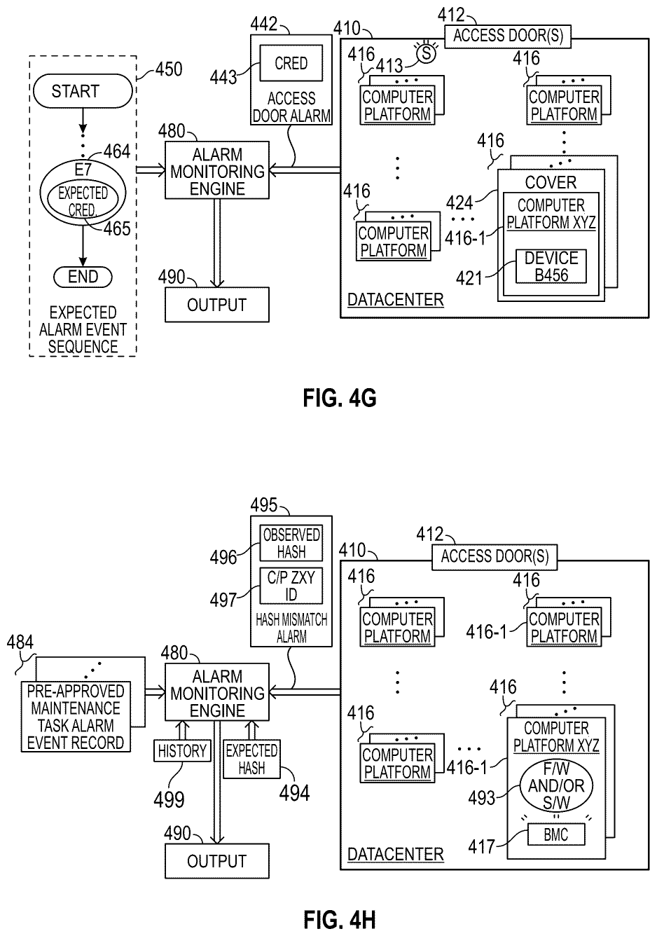

An example expected alarm event sequence 200 (corresponding to a particular pre-approved maintenance task alarm event record) is depicted in FIG. 2 and is described further herein. An example technique 300 depicting an alarm monitoring engine's analysis of an alarm for purposes of determining whether the underlying alarm event is expected or unexpected is depicted in FIG. 3 and is described further herein. Specific examples of alarms and alarm event entries processed by an alarm monitoring engine are depicted in FIGS. 4A to 4G and are described further herein.

Still referring to FIG. 1B, in accordance with example implementations, the alarm monitoring engine 180 is hosted on resources 192. The resources 192 include one or multiple hardware processors 194 and a memory 196. A hardware processor 194 may include one or multiple CPU cores, one or multiple GPU cores or a combination of CPU and GPU cores. In general, the memory devices that form the memory 196, as well as other memories and storage media that are described herein, may be formed from non-transitory memory devices, such as semiconductor storage devices, flash memory devices, memristors, phase change memory devices, a combination of one or more of the foregoing storage technologies, and so forth. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

In an example, the resources 192 correspond to a particular computer platform (e.g., a computer platform 116 of FIG. 1A) of a datacenter (e.g., the secure datacenter 110 of FIG. 1A) that is monitored by the alarm monitoring engine 180. In another example, the resources 192 correspond to a computer platform that is outside of a datacenter that is monitored by the alarm monitoring engine 180. For example, the resources 192 may be located in a datacenter other than the datacenter that is monitored by the alarm monitoring engine 180. In another example, the resources 192 corresponding to a cloud, such as a public cloud, private cloud or hybrid cloud. In another example, the alarm monitoring engine 180 monitors a private datacenter, the resources 192 correspond to a public cloud, and the alarm monitoring engine 180 corresponds to an “as-a-Service”model.

As used herein, an “engine,” such as the alarm monitoring engine 180 or the above-described hash monitoring engine, can refer to one or multiple circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. In an example, instructions 198 that are stored in the memory 196 may be executed by one or multiple hardware processors 194 to cause the processor(s) 194 to perform one or multiple functions for the alarm monitoring engine 180, as described herein. Alternatively, an “engine,” in accordance with further implementations, such as the alarm monitoring engine 180, may be solely limited to one or multiple hardware processing circuits that do not execute machine-readable instructions. In another variation, the alarm monitoring engine 180 is a combination of one or multiple hardware processing circuits that do not execute machine-readable instructions and hardware processors that execute machine-readable instructions.

FIG. 2 is an example expected alarm event sequence 200 for a pre-approved maintenance task to remove a hardware component A123 (e.g., an older version GPU card) of a computer platform XYZ and replace the hardware component A123 with a hardware component B456 (e.g., a newer version GPU card). In an example, the expected alarm event sequence 200 is described by data of a pre-approved maintenance task alarm event record, such as a pre-approved maintenance task alarm event record 184 discussed above in connection with FIGS. 1A and 1B. In this manner, alarm event entries of the pre-approved maintenance task alarm event record correspond to seven expected alarm events 204, 208, 212, 216, 220, 224 and 228 of the expected alarm event sequence 200. An alarm monitoring engine, such as the alarm monitoring engine 180 of FIGS. 1A and 1B, uses the expected alarm event sequence 200 to determine that the alarm events for work performed for the corresponding pre-approved maintenance task are expected. Moreover, the alarm monitoring engine may also determine, from the expected alarm event sequence 200 and other expected alarm event sequences, that a given alarm event is not related to a pre-approved maintenance task and is therefore, unexpected.

The alarm events 204, 208, 212, 216, 220, 224 and 228 are expected to be observed in a particular time order 201. Stated differently, the expected alarm event 204 occurs first and before the expected alarm event 208, the expected alarm event 208 occurs next before expected alarm event 212, and so forth, with the expected alarm event 228 occurring last. The alarm events 204, 208, 212, 216, 220, 224 and 228 are associated with information units 206, 210, 214, 218, 222, 226 and 230, respectively, which correspond to the respective alarm event entries of the pre-approved maintenance task alarm event record. The information units 206, 210, 214, 218, 222, 226 and 230 allow the alarm monitoring engine to match observed alarms to alarm events 204, 208, 212, 216, 220, 224 and 228.

The first alarm event 204 of the expected alarm event sequence 200 corresponds to a datacenter entry alarm, i.e., an alarm indicating detection of entry of a person through an access door and into the secure datacenter. In an example, the associated information unit 206 includes data that represents the credentials of a person who is authorized to perform the pre-approved maintenance task. Opening the datacenter access door, for this example, involves providing credentials (e.g., providing credentials via a badge reader, through input on a keypad, or by providing biometric input) that, as examples, cause the access door to be automatically opened or cause a lock on the access door to be released so that the door can be manually opened.

The second alarm event 208 of the expected alarm event sequence 200 corresponds to a tamper prevention cover open alarm corresponding to the tamper prevention cover of the computer platform XYZ being removed. The second alarm event 208 is associated with a unit of information 210 that allows the alarm monitoring engine to determine whether a given tamper prevention cover alarm corresponds to the expected alarm event sequence 200 and corresponds to the alarm event 208. In an example, the unit of information 210 includes data representing an identifier for the computer platform XYZ.

The third alarm event 212 of the expected alarm event sequence 200 corresponds to a computer platform power down alarm due to the computer platform XYZ being powered down. In an example, the associated unit of information 214 represents an identifier for the computer platform XYZ.

After the computer platform XYZ is powered down, the next action of the pre-approved maintenance task is to replace the hardware component A123 with the hardware component B456. As depicted in FIG. 2, the replacement occurs after the third alarm event 212 (corresponding to the computer platform XYZ being powered down) and before the fourth alarm event 216, which is a computer platform power up alarm due to the computer platform XYZ being powered up. The unit of information 218 associated with the fourth alarm event 216 specifies an identifier for the computer platform XYZ.

The newly-installed hardware component B456 does not correspond to the base platform certificate or any delta platform certificate installed on the computer platform XYZ. Accordingly, when the computer platform XYZ powers up, a BMC of the computer platform XYZ detects an inventory change and generates a platform certificate mismatch alarm. Therefore, the next alarm event 220 for the expected alarm event sequence 200 corresponds to a platform certificate mismatch alarm, and the associated unit of information 222 allows the alarm monitoring engine to determine that the platform certificate mismatch alarm is expected. In an example, the unit of information 222 includes data that represents that the hardware component A123 has been removed and further represents that the hardware component B456 has been added.

The remaining alarm events 224 and 228 of the expected alarm event sequence 200 occur near the end of the pre-approved maintenance task. More specifically, the alarm event 224 corresponds to a tamper prevention cover closed alarm, which is generated due to the tamper prevention cover of the computer platform XYZ being reinstalled. In an example, the associated unit of information 226 for the alarm event 224 specifies an identifier for the computer platform XYZ. The alarm event 228 corresponds to a datacenter exit alarm due to a detected exit from the datacenter through an access door. This corresponds to the authorized person associated with the pre-approved maintenance task leaving the datacenter. In an example, the alarm event 228 is associated with a unit of information 230 that specifies the credentials of the person.

FIG. 3 depicts an alarm monitoring technique 300 that may be performed by an alarm monitoring engine to process a particular alarm. The generation of the alarm is triggered by a corresponding alarm event, which is referred to herein as the “underlying alarm event.” The alarm monitoring engine 180 of FIGS. 1A and 1B is an example of an alarm monitoring engine that may perform the technique 300.

Pursuant to the technique 300, the alarm monitoring engine first identifies an alarm event category, or type, corresponding to the alarm. In examples, the alarm event category may be a datacenter entry alarm, a tamper prevention cover open alarm, a computer platform power down alarm, a computer platform power up alarm, a platform certificate mismatch alarm, a tamper prevention cover closed alarm, a datacenter exit alarm, a hash mismatch alarm, or any other alert or notification corresponding to a physical security attack indicator.

Pursuant to block 308, the alarm monitoring engine, based on pre-approved maintenance task alarm event records, identifies any expected alarm event sequence that contains an alarm event corresponding to the identified alarm event category. If, pursuant to decision block 312, the alarm monitoring engine determines that no expected alarm event sequence has been identified, then the alarm is unexpected and the alarm monitoring engine escalates the alarm, as depicted in block 316.

If, however, the alarm monitoring engine determines, in decision block 316 that one or multiple expected alarm event sequences were identified in block 308, then the alarm monitoring engine, pursuant to block 320, determines if at least one of the identified expected alarm event sequences is valid. For an expected alarm event sequence to be valid, in this context, the observed history of the pre-approved maintenance task (e.g., a history indicated by an associated observed maintenance task work history record) is consistent with the time order of the expected alarm event sequence. A valid expected alarm sequence is considered to be a “candidate” expected alarm sequence. There may be zero, one or multiple valid candidate expected alarm sequences for a given alarm.

In an example, an expected alarm event sequence contains an alarm event E2 that corresponds to a tamper prevention cover open alarm for computer XYZ, and the next alarm event E3 of the sequence corresponds to a computer platform power down alarm for the computer XYZ. It is assumed for this example that the observed maintenance task work history indicates that a tamper prevention cover open alarm has already been observed and matched, by the alarm monitoring engine, to the alarm event E2. Therefore, given the observed maintenance task work history, the expected alarm event sequence is a valid candidate sequence for the alarm monitoring engine to consider for purposes of evaluating a computer platform power down alarm.

In another example, an expected alarm event sequence contains alarm event E1 that corresponds to a datacenter entry alarm, and the next alarm event E2 of the sequence corresponds to a tamper prevention cover open alarm for a particular computer platform. It is assumed for this example that the observed maintenance task work history indicates that no alarm events for this pre-approved maintenance task have been observed (i.e., work on the pre-approved maintenance task has not begun). Stated differently, the person authorized to perform the pre-approved maintenance task has not yet entered the datacenter. Therefore, given the observed maintenance task work history, this example expected alarm event sequence is not a valid sequence for the alarm monitoring engine to consider for a tamper prevention cover removal alarm, as the alarm event E1 for this example expected alarm event sequence has not yet been detected.

If, pursuant to decision block 324, the alarm monitoring engine, identifies one or multiple valid candidate expected alarm event sequences, then the alarm monitoring engine, pursuant to block 328, determines, if the underlying alarm event corresponds to one of the valid candidate sequences. If so, the underlying alarm event is expected, and otherwise, the alarm event is unexpected.

In an example, for a tamper prevention cover open alarm for computer platform XYZ, the alarm monitoring engine identifies valid candidate expected alarm event sequences A and B. Candidate expected alarm event sequence A has an alarm event that corresponds to a tamper prevention cover open alarm for computer platform ABC. Candidate expected alarm event sequence B has an alarm event that corresponds to a tamper prevention cover open alarm for computer platform XYZ. Therefore, for this example, the underlying alarm event corresponds to candidate expected alarm sequence B and is therefore expected.

In another example, for a computer platform power down alarm for a computer platform DEF, the alarm monitoring engine identifies valid candidate expected alarm event sequences A, B and C. None of the computer platform power down alarm events for these three sequences, however, are associated with computer platform DEF. Therefore, for this example, the underlying alarm event, is unexpected.

If, pursuant to decision block 332, the alarm monitoring engine determines that the underlying alarm event is unexpected, then the alarm monitoring engine escalates the alarm, as depicted at 316. If, pursuant to decision block 332, the alarm monitoring engine determines that the underlying alarm event is expected, then the alarm monitoring engine updates (block 336) the observed maintenance task history record and suppresses the alarm, as depicted in block 340.

FIGS. 4A-4G depict states of a secure datacenter 410 corresponding to events that occur as pre-approved maintenance task work is performed to replace a hardware component of a computer platform 416-1. The pre-approved maintenance task work corresponds to an expected alarm event sequence 450, which is similar to the expected alarm event sequence 200 of FIG. 2. The pre-approved maintenance task work for this example involves replacing a hardware device A123 of a computer platform 416-1 with a hardware device B456. The expected alarm event sequence 450 is represented by data of a pre-approved maintenance task alarm event record. The computer platform 416-1 is one of multiple computer platforms 416 of the secure datacenter 410. The computer platform 416-1 is referred to in the following description as “computer platform XYZ.” It is assumed that a particular person 426 is authorized to perform the work on the pre-approved maintenance task. Moreover, it is assumed that each of the example states depicted in FIGS. 4A-4G, the alarm monitoring engine 480 has determined that for the example alarms, the expected alarm event sequence 450 is valid, and furthermore, each of the example underlying alarm events occurs at the appropriate time as indicated by an observed maintenance task work history for the expected alarm event sequence 450.

Referring to FIG. 4A, work on the pre-approved maintenance task begins by the authorized person 426 entering the datacenter 410 through an access door 412. A sensor 414 detects entry into the datacenter 410, which causes the generation of a corresponding access door alarm 430. The sensor 414 is part of an alarm event detector (e.g., an alarm event detector that includes a BMC). The access door alarm 430 is associated with data that represents credentials 431 that were provided by the authorized person 426 to gain entry through the access door 412.

The access door alarm 430 is received and processed by an alarm monitoring engine 480. The alarm monitoring engine 180 of FIGS. 1A and 1B is an example of the alarm monitoring engine 480. The alarm monitoring engine 480 processes the access door alarm 430 for purposes of determining whether the underlying alarm event corresponding to the alarm 430 is expected or unexpected. The output 490 of the alarm monitoring engine 480 depends on whether the engine 480 determines that the underlying alarm event is expected or unexpected. For this example, the alarm monitoring engine 480 determines that the access door alarm 430 corresponds to the first alarm event 451 of the expected alarm event sequence 450. The alarm event 451 corresponds to an access door alarm and is associated with expected credentials 452. If the expected credentials 452 correspond to the observed credentials 431, then the alarm monitoring engine 480 determines that the underlying alarm event is expected, and the alarm monitoring engine 480 suppresses the alarm 430.

As further depicted in FIG. 4A, a person 428 other than the authorized person 426 is present inside the secure datacenter 410. In an example, the other person 428 closely followed behind the authorized person 426 (i.e., “tail gated” the person 426) to gain unauthorized access to the secure datacenter 410. However, even though the person 428 is not authorized to be inside the secure datacenter 410, any physical security attack-related action performed by the person 428 causes generation of an alarm, which the alarm monitoring engine 480 would determine is associated with an unexpected alarm event. Accordingly, any such action taken by the unauthorized person 426 causes the alarm monitoring engine 480 to escalate the alarm triggered by this action. In another example, the person 428 may be authorized to perform a particular approved maintenance task inside the datacenter 410. If the person 428, although authorized to be in the datacenter 410, performs an unauthorized action, then the alarm monitoring engine 480 would escalate the corresponding alarm triggered due to that action, as the action is not permitted given the observed maintenance task work history of the approved maintenance task and the pre-approved maintenance task alarm event records.

Referring to FIG. 4B, the authorized person 426 next, as part of the pre-approved maintenance task, opens or removes a tamper prevention cover 424 of the computer platform XYZ. A sensor 415 detects the opening of the tamper prevention cover, and this detection triggers a corresponding cover open alarm 432. In an example, the sensor 415 may be part of an alarm event detector (e.g., an alarm event detector that includes a BMC of the computer platform XYZ). The cover open alarm 432 is associated with data that represents an identifier 433 for the computer platform XYZ. The alarm monitoring engine 480 matches the cover open alarm 432 to an alarm event 453 of the expected alarm event sequence 450. The alarm event 453 is associated with information 454 that identifies the computer platform XYZ. For this example, the alarm monitoring engine 480 determines that the underlying alarm event is expected, as the computer platform identifier 433 matches an identifier 454 associated with the alarm event entry 453. Accordingly, for this example, the alarm monitoring engine 480 suppresses the cover open alarm 432. Alternatively, if, for example, a tamper prevention cover open alarm identifies a computer platform 416 other than computer platform XYZ, then the alarm event 453 would not be applicable.

Referring to FIG. 4C, the next action taken by the authorized person 426, as part of the pre-approved maintenance task, is to, after removing the tamper prevention cover 424, power down the computer platform XYZ. The powering down of the computer platform XYZ results in a corresponding computer platform power off alarm 434. In an example, a BMC 417 of the computer platform XYZ corresponds to an alarm event detector, detects powering down of the computer platform XYZ and generates the computer platform power off alarm 434. In an example, the BMC 417 may be powered by an auxiliary power supply, and the powering down of the computer platform XYZ refers to the powering down of a primary power supply of the computer platform XYZ. The auxiliary power supply supports functions of the BMC 417, including the functions related to the BMC 417 monitoring the primary power supply status and allowing the BMC 417 to communicate with the alarm monitoring engine 480.

The alarm monitoring engine 480, for this example, determines that the computer platform power off alarm 434 corresponds to an alarm event 455 of the expected alarm event sequence 450. The alarm event entry 455 is associated with an identifier 456 of the computer platform XYZ. For this example, the computer platform power off alarm 434 is associated with a computer platform identifier 435 that corresponds to the computer platform XYZ. Therefore, the alarm monitoring engine 480 determines that the computer platform power off alarm 434 corresponds to an expected alarm event and correspondingly, suppresses the alarm 434.

While the primary power of the computer platform XYZ is turned off, an authorized person 426 may then replace a hardware device 420 of the computer platform XYZ with another hardware device. The hardware device 420 is referred to herein as the “hardware device A123.” When the primary power for the computer platform XYZ is powered off, it is possible that the person 426, although authorized to replace the hardware device A123, may perform other unauthorized actions on the computer platform XYZ. In an example, another hardware component of the computer platform XYZ may be replaced. For example, the approved maintenance task may be to replace a DIM module, but the person 426 proceeds to replace a NIC card. In another example, the person 426 may remove an SSD drive on the computer platform XYZ, add malicious software to the SSD drive, and then reinstall the SSD drive on the computer platform XYZ. In another example, the person 426 may have a NAND flash programmer to reprogram a non-volatile memory device of the computer platform XYZ for purposes of downgrading system firmware to a lower, more security vulnerable version. In another example, the person 426 may replace a GPU card on the computer platform XYZ. As described herein, however, even though any of the above-described actions is outside of the scope of the pre-approved maintenance task, any alarms resulting from these actions are escalated by the alarm monitoring engine 480 because the underlying alarm events are unexpected, as the events are not authorized according to any pre-approved maintenance task alarm event record.

Referring to FIG. 4D, it is assumed in this example that the hardware device A123 is replaced with another hardware device 421 that is referred to herein as the “hardware device B456.” After installing the hardware device B456, the person 426 proceeds to power the computer platform XYZ back up. It is assumed for this example that the BMC 417 corresponds to an alarm event detector for purposes of detecting a power up of the computer platform XYZ and generating a corresponding power on alarm, such as example power on alarm 436. Therefore, the powering up of the computer platform XYZ in turn causes the BMC 417 to generate the example computer platform power on alarm 436. The computer platform power on alarm 436 is associated with data that represents an identifier 437. The identifier 437 associates the computer platform power on alarm 436 with the computer platform XYZ. For this example, the alarm monitoring engine 480 associates the computer platform power on alarm 436 with a corresponding alarm event 457 of the expected alarm event sequence 450. The alarm event 457 is associated with information 458 that identifies the computer platform XYZ. Therefore, for this example, the alarm monitoring engine 480 determines that the underlying alarm event is expected and correspondingly, suppresses the computer platform power on alarm 436.

Referring to FIG. 4E, it is assumed for this example that the BMC 417 corresponds to an alarm event detector for purposes of detecting unexpected inventory changes for the computer platform XYZ and generating corresponding platform mismatch alarms. Upon the computer platform XYZ powering up after replacement of the hardware device A123 with the hardware device B456, the BMC 417 determines an inventory of hardware and firmware components of the computer platform XYZ. For this example, the BMC 417 determines that the computer platform XYZ does not contain a delta platform certificate showing the removal of the hardware device A123 and the installation of the hardware device B456. Accordingly, the BMC 417 generates a platform certificate mismatch alarm 438.

The platform certificate mismatch alarm 438 is associated with data that represents an observed inventory for the computer platform XYZ. In an example, the platform mismatch alarm 438 includes data that represents an observed delta platform certificate 439 for the computer platform XYZ. In another example, the data represents an observed inventory of all components for the computer platform XYZ. In another example, the data represents the detected changes in the computer platform's inventory relative to the expected inventory represented by expected base and delta platform certificates.

For this example, the alarm monitoring engine 480 determines that the platform certificate mismatch alarm 438 corresponds to an alarm event 459 of the expected alarm event sequence 450. The alarm event 459 includes information that allows the alarm monitoring engine 480 to determine that the platform certificate mismatch alarm 438 is expected. More specifically, as depicted in FIG. 4E, the alarm event 459 is associated with information 461 that identifies the computer platform XYZ and information 460 that identifies the addition of the hardware device B456. Moreover, the alarm event 459 may be associated with information that the hardware device A123 has been removed. The alarm monitoring engine 480 may evaluate one or multiple expected platform certificates (e.g., a base platform certificate and one or multiple delta platform certificates) for the computer platform XYZ for purposes of determining whether the expected inventory of the computer platform XYZ, after the replacement of device A123 with hardware device B456, is the same as the now observed inventory of the computer platform XYZ. In this example, the alarm monitoring engine 480 determines that the observed inventory matches the expected inventory, and therefore, determines that the underlying alarm event is expected. If the person 426 hypothetically installs firmware, removes firmware, installs a hardware device, or removes a hardware device that does not correspond to information associated with the alarm event 459, then the alarm monitoring engine 480 is unable to match the alarm event 459 to the platform certificate mismatch alarm 438, and correspondingly, the alarm monitoring engine 480 escalates the corresponding platform certificate mismatch alarm 438.

Referring to FIG. 4F, the next action according to the pre-approved maintenance task is for the person 426 to replace the tamper prevention cover 424 on the computer platform XYZ. Replacing the tamper prevention cover is detected by a sensor 415, which causes the generation of a tamper prevention cover closed alarm 440. In an example, a BMC of the computer platform XYZ corresponds to an alarm event detector that detects closing of the computer platform's tamper prevention cover and in response to such a detection, generates the tamper prevention cover closed alarm 440. The tamper prevention cover closed alarm 440 is associated with data that represents an identifier 441 of the computer platform XYZ. The alarm monitoring engine 480 identifies an alarm event 462 of the expected alarm event sequence. The alarm event 462 is associated with information 463 that identifies the computer platform XYZ. Accordingly, the underlying alarm event is expected, and the alarm monitoring engine 430 suppresses the tamper prevention cover closed alarm 440.

Referring to FIG. 4G, the last action taken by the person 426 within the scope of the pre-approved maintenance task is to exit the secure datacenter 410. The exiting of the person 426, in turn, is detected by a sensor 413 of a corresponding alarm event detector, which causes the alarm event detector to generate an access door alarm 442. The access door alarm 442 is associated with data that represents credentials 443 provided by the person 426 leaving the secure datacenter 410. The alarm monitoring engine 480 associates the access door alarm 442 with an alarm event 464 of the expected alarm event sequence 450. The alarm event 464 is associated with data that represents expected credentials 465 of the person associated with the access door alarm 442. For this example, the expected credentials 465 correspond to the credentials 443 provided by the person 426. Accordingly, the alarm monitoring engine 480 determines that the underlying alarm event is expected, and the alarm monitoring engine 480 suppresses the access door alarm 442.

FIG. 4H depicts a scenario occurring when a hash mismatch alarm 495 is generated for the computer platform XYZ. The hash mismatch alarm 495 may be generated by any of a number of different alarm event detectors. In examples, the alarm event detector may correspond to a BMC of the computer platform XYZ, an operating system kernel agent of the computer platform XYZ, a verifier other than the computer platform XYZ, a datacenter hash monitoring engine, or another entity. For this example, the hash mismatch alarm 495 is generated due to firmware and/or software 493 of the computer platform XYZ having a corresponding observed hash that differs from an expected hash or the mismatch may be due a physical security attack. For example, in performing the pre-approved maintenance task described above in connection with FIGS. 4A-4G, the person approved to perform this pre-approved maintenance task may have introduced an unauthorized program on an SSD of the computer platform XYZ, while the computer platform XYZ was powered down.

For this example, the hash mismatch alarm 495 is associated with data that represents an observed hash 496 for the computer platform XYZ and further represents an identifier 497 for the computer platform XYZ. The alarm monitoring engine 480 may, for example, responsive to the hash mismatch alarm 495, be unable to identify a corresponding expected alarm event sequence represented by any pre-approved maintenance task alarm event record 484 considering the observed maintenance task work history 499 provided by the corresponding observed maintenance task work history records. As such, the alarm monitoring engine determines that the underlying alarm event is unexpected, and the alarm monitoring engine 480 escalates the hash mismatch alarm 495.

In another example, the alarm monitoring engine 480 may determine that the hash mismatch alarm 495 corresponds to a pre-approved maintenance task to upgrade certain software or firmware on the computer platform XYZ. Accordingly, for this example, the pre-approved maintenance task corresponds to a particular pre-approved maintenance task alarm event record 484, and the pre-approved maintenance task alarm event record 484 represents an expected alarm sequence that contains an alarm event that corresponds to the underlying alarm event for the hash mismatch alarm 495. Correspondingly, for this example, the alarm monitoring engine 480 determines that the underlying alarm event is expected and suppresses the hash mismatch alarm 495.

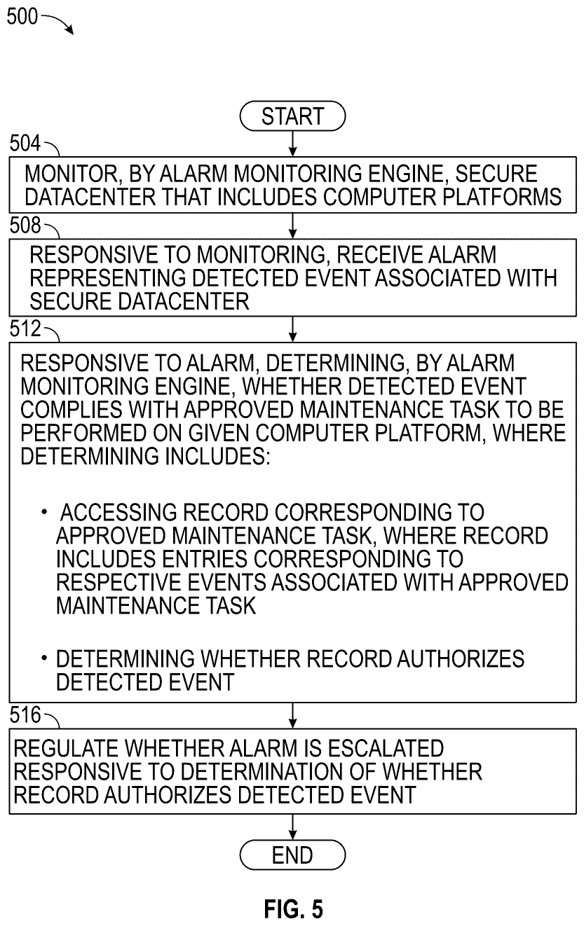

Referring to FIG. 5, in accordance with example implementations, a technique 500 includes monitoring (block 504), by an alarm monitoring engine, a secure datacenter that includes computer platforms. In an example, the secure datacenter has security controls to inhibit and detect physical security attacks on its computer platforms. The alarm monitoring engine is an example of a security control. In an example of a security control, the secure datacenter has a controlled access perimeter. In an example, entry through the controlled access perimeter is regulated through one or multiple access doors, which also are examples of security controls. In an example, an access door has an associated access control device (e.g. a keypad, a badge reader or a biometric scanner) and a locking operator so that entry through the access door is permitted for authorized credentials (e.g., certain passcodes, certain badge identifiers and certain fingerprints) and not permitted otherwise. In an example, an access door may allow both entry into the secure datacenter and exit from the secure datacenter. In another example, a pair of interlocking access doors may be part of an access control vestibule, which includes a physical space between the interlocking access doors. The operations of the interlocking access doors are coordinated to allow either a controlled exit from the secure datacenter through one of the interlocking access doors or a controlled entry into the secure datacenter through the other interlocking access door. In other examples of security controls, the secure datacenter may include physical security barriers, security guard-enforced access entry points, security guard patrols and camera surveillance.

In an example, the computer platforms may be servers, such as enclosure-based servers (e.g., blade servers), rack servers (e.g., DL servers), tower servers or a combination of the foregoing servers. In an example, the secure datacenter may have rows of racks, and multiple computer platforms may be mounted in each rack.

The technique 500 includes, responsive to the monitoring, receiving (block 508), by the alarm monitoring engine, an alarm that represents a detected event associated with the secure datacenter. In an example, the alarm is a datacenter access door entry alarm. In another example, the alarm is a datacenter access door exit alarm. In another example, the alarm is a tamper prevention cover open alarm associated with a particular computer platform. In another example, the alarm is a tamper prevention cover closed alarm associated with a particular computer platform. In another example, the alarm is a computer platform power down alarm associated with a particular computer platform. In another example, the alarm is a computer platform power up alarm associated with a particular computer platform. In another example, the alarm is a platform certificate mismatch alarm associated with a particular computer platform. In another example, the alarm is a hash mismatch alarm associated with a particular computer platform.

Pursuant to block 512, the technique 500 includes, responsive to the alarm, determining, by the alarm monitoring engine, whether the detected event complies with an approved maintenance task to be performed on a given computer platform. In an example, the secure datacenter has a policy for all maintenance tasks to be pre-approved before work begins on the maintenance tasks. In an example, the secure datacenter has a policy for all a pre-approved maintenance task alarm event record to be created before work begins on a corresponding pre-approved maintenance task. In an example, a pre-approved maintenance task alarm event record includes data that represents an expected time sequence of alarm events for the corresponding pre-approved maintenance task. In an example, a pre-approved maintenance task alarm event record includes data that represents alarm event entries corresponding to respective alarm events, with each alarm event entry specifying an alarm type of the alarm event and information about the alarm event.

Determining whether the detected event complies with the approved maintenance task, includes, pursuant to block 512, accessing a record corresponding to the approved maintenance task. The record includes entries corresponding to respective expected events that are associated with the approved maintenance task. Determining whether the detected event complies with the approved maintenance task, pursuant to block 512, further includes determining whether the record authorizes the detected event. In an example, determining whether the record authorized the event includes whether the record contains an alarm event entry that corresponds to the detected event. In an example, determining whether the record authorizes the event includes determining whether the record is valid based on an observed history for the approved maintenance task.

The technique 500 includes regulating (block 516) whether the alarm is escalated responsive to the determination of whether the record authorizes the detected event. In an example, the alarm monitoring engine determines that the record does not authorize the detected event, and the alarm monitoring engine generates an alarm directed to a datacenter administrator or other administrative personnel. In another example, the alarm monitoring engine determines that the record authorizes the detected event, and the alarm monitoring engine updates an observed maintenance task history corresponding to the record and suppresses the alarm.

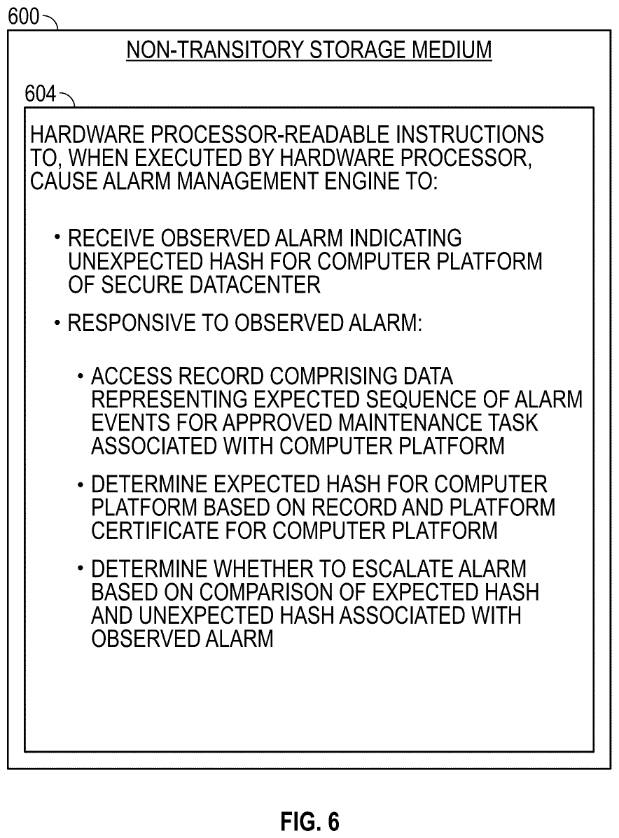

Referring to FIG. 6, in accordance with example implementations, a non-transitory storage medium 600 stores hardware processor-readable instructions 604. The instructions 604, when executed by a hardware processor, cause an alarm management engine to receive an observed alarm event indicating an unexpected hash for a computer platform of a secure datacenter. In an example, the computer platform is a server. In an example, the server is an enclosure-based server, such as a blade server. In another example, the server is a rack server, such as a DL server. In another example, the server is a tower server.

In an example, the unexpected hash corresponds to an attestation value derived during a measured boot of the computer platform. In another example, the unexpected hash corresponds to firmware of the computer platform. In another example, the unexpected hash corresponds to software of the computer platform. In another example, the unexpected hash corresponds to a node of a Merkle tree.

The instructions 604, when executed by the hardware processor, further cause the alarm management engine to, responsive to the observed alarm event, access a record that includes an expected sequence of alarm events for an approved maintenance task associated with the computer platform. In an example, the secure datacenter has a policy for all maintenance tasks to be pre-approved before work begins on the maintenance tasks. In an example, the secure datacenter has a policy for all a pre-approved maintenance task alarm event record to be created before work begins on a corresponding pre-approved maintenance task. In an example, a pre-approved maintenance task alarm event record includes data that represents an expected time sequence of alarm events for the corresponding pre-approved maintenance task. In an example, a pre-approved maintenance task alarm event record includes data that represents alarm event entries corresponding to respective alarm events, with each alarm event entry specifies an alarm type of the alarm event and information about the alarm event.

The instructions 604, when executed by the hardware processor, further cause the hardware processor to, responsive to the observed alarm event, determine an expected hash for the computer platform based on the record and a platform certificate for the computer platform. In an example, the record contains data representing information about a firmware or software change for the computer platform. In an example, the platform certificate is a base platform certificate. In an example, the hardware processor further determines the expected hash based on one or multiple delta platform certificates for the computer platform.

The instructions 604, when executed by the hardware processor, further cause the alarm management engine to determine whether to escalate the observed alarm event responsive to the determination of whether the observed alarm event is expected. In an example, the alarm management engine generates an alarm directed to a datacenter administrator or other administrative personnel.

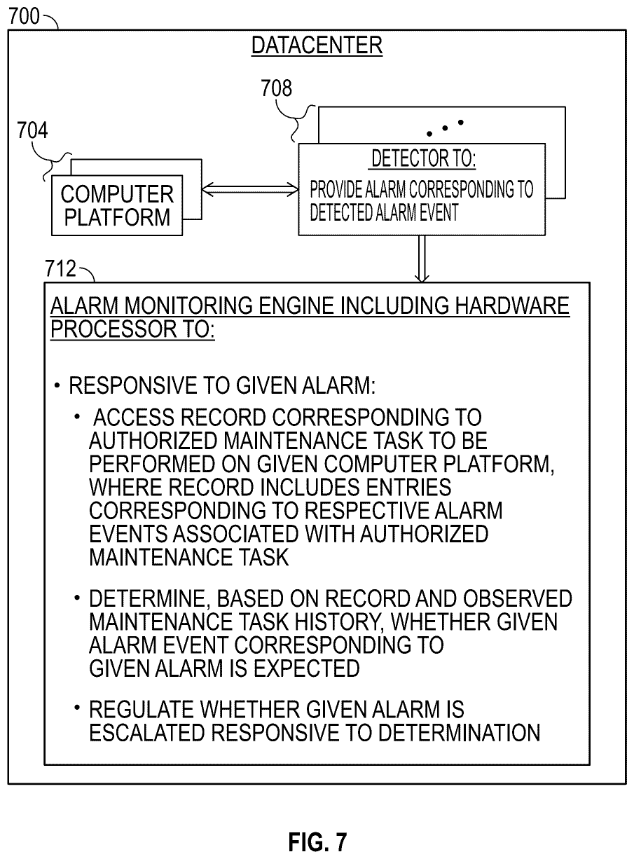

Referring to FIG. 7, in accordance with example implementations, a datacenter 700 includes computer platforms 704, detectors 708 and an alarm monitoring engine 712. The detectors 708 provide alarms representing detected alarm events that are associated with the computer platforms 704. In an example, the computer platforms may be servers, such as enclosure-based servers (e.g., blade servers), rack servers (e.g., DL servers), tower servers or a combination of the foregoing servers. In an example, the secure datacenter may have rows of racks, and multiple computer platforms may be mounted in each rack.

In examples, a given detector may detect and generate alarms for detected alarm events corresponding to one of the following alarm event categories: datacenter access door entry, tamper prevention cover removal, computer platform power down, computer platform power down, computer platform power up, tamper prevention cover open, tamper prevention cover closed, platform certificate mismatch, datacenter access door exit, among other and/or different categories.

In an example, a detector is located on-board a particular computer platform; detects alarm events corresponding to the computer platform and corresponding to a particular alarm event category; and generates alarms in response to detection of these alarm events. In another example, a computer platform may have multiple on-board detectors that detect alarm events corresponding to multiple alarm event categories. In another example, a detector is not associated with a particular computer platform, but rather, the detector detects alarm events that are non-computer platform specific but nevertheless are indicators for physical security attacks conducted inside the datacenter. In an example, a detector is dedicated to detecting a particular alarm event and generating alarms responsive to detection of these alarm events. In another example, a detector includes one or multiple components which, in addition to performing alarm-related functions, perform functions unrelated to detecting alarm events or generating alarms.

In an example, a detector corresponds to a BMC. In another example, a detector corresponds to an operating system kernel agent. In another example, a detector corresponds to a chassis controller. In another example, a detector corresponds to a smart I/O peripheral. In another example, a detector corresponds to an attestation verifier. In another example, a detector corresponds to a hash monitoring engine. In another example, a detector is associated with an access door. In another example, a detector is associated with an access door vestibule.

The alarm monitoring engine 712 includes a hardware processor that, responsive to the given alarm, accesses a record corresponding to an authorized maintenance task to be performed on a given computer platform. The record includes entries corresponding to respective expected detected alarm events associated with the authorized maintenance task. In an example, the hardware processor includes one or multiple CPU cores and/or one or multiple GPU cores. In an example, the secure datacenter has a policy for all maintenance tasks to be pre-approved before work begins on the maintenance tasks. In an example, the secure datacenter has a policy for all a pre-approved maintenance task alarm event record to be created before work begins on a corresponding pre-approved maintenance task. In an example, a pre-approved maintenance task alarm event record includes data that represents an expected time sequence of alarm events for the corresponding pre-approved maintenance task. In an example, a pre-approved maintenance task alarm event record includes data that represents alarm event entries corresponding to respective alarm events, with each alarm event entry specifies an alarm type of the alarm event and information about the alarm event.

The hardware processor, responsive to the given alarm, determines, based on the record and an observed maintenance task history, whether an alarm event corresponding to the given alarm is expected. In an example, a maintenance task work history record is associated with the observed maintenance task work history. In an example, the maintenance task work history record contains data that represents the current state of a pre-approved maintenance task. In an example, a maintenance task work history record includes data representing the specific alarm events (if any) for the associated pre-approved maintenance task, which have been observed by the alarm monitoring engine. In an example, the maintenance task work history record reveals no observed alarm events for an associated pre-approved maintenance task for which work has yet to begin. In another example, the maintenance task work history record lists a set of observed alarm events for an associated pre-approved maintenance task. In another example, the maintenance task work history record indicates that the associated pre-approved maintenance task is complete, as all alarm events have been observed by the alarm monitoring engine.

The hardware processor, responsive to the given alarm, regulates whether the alarm is escalated responsive to the determination. In an example, the alarm monitoring engine determines that the record does not authorize the detected event, and the alarm monitoring engine generates an alarm directed to a datacenter administrator or other administrative personnel. In another example, the alarm monitoring engine determines that the record authorizes the detected event, and the alarm monitoring engine updates an observed maintenance task history corresponding to the record and suppresses the alarm.

In accordance with example implementations, determining whether the record authorizes the detected event includes determining whether the detected event corresponds to a given expected event. Regulating whether the alarm is escalated includes suppressing the alarm responsive to determining that the detected event corresponds to the given expected event. Among potential advantages, managing datacenter alarms based on pre-approved maintenance task alarm event records accurately detects physical security attacks, regardless of whether or not authorized maintenance task work is being performed in the datacenter.

In accordance with example implementations, the entries are ordered according to an expected sequence for the expected events. Determining whether the record authorizes the detected event includes determining whether an observed sequence associated with the detected event corresponds to the expected sequence. Regulating whether the alarm is escalated includes escalating the alarm responsive to determining that the observed sequence does not correspond to the expected sequence. Among potential advantages, managing datacenter alarms based on pre-approved maintenance task alarm event records accurately detects physical security attacks, regardless of whether or not authorized maintenance task work is being performed in the datacenter.

In accordance with example implementations, the detected event includes a detected opening of an access door of the secure datacenter. Determining whether the record authorizes the detected event includes determining whether the record authorizes a credential provided by a person that is associated with the detected opening. Among potential advantages, managing datacenter alarms based on pre-approved maintenance task alarm event records accurately detects physical security attacks, regardless of whether or not authorized maintenance task work is being performed in the datacenter.

In accordance with example implementations, the detected event includes a detected opening or closing of an access cover of a computer platform. Determining whether the record authorizes the detected event includes determining whether the record authorizes the detected opening or closing of the access cover. Among potential advantages, managing datacenter alarms based on pre-approved maintenance task alarm event records accurately detects physical security attacks, regardless of whether or not authorized maintenance task work is being performed in the datacenter.

In accordance with example implementations, the detected event includes a detected powering on or off of a computer platform. Determining whether the record authorizes the detected event includes determining whether the record authorizes the powering on or off. Among potential advantages, managing datacenter alarms based on pre-approved maintenance task alarm event records accurately detects physical security attacks, regardless of whether or not authorized maintenance task work is being performed in the datacenter.

In accordance with example implementations, the detected event includes a detected mismatch between an expected platform certificate for a computer platform and an observed platform certificate of the computer platform. Determining whether the record authorizes the detected event includes determining whether the record authorizes the observed platform certificate. Among potential advantages, managing datacenter alarms based on pre-approved maintenance task alarm event records accurately detects physical security attacks, regardless of whether or not authorized maintenance task work is being performed in the datacenter.

In accordance with example implementations, a given expected event corresponds to the detected mismatch. The entry corresponding to the given expected event includes data to verify the observed platform certificate. Among potential advantages, managing datacenter alarms based on pre-approved maintenance task alarm event records accurately detects physical security attacks, regardless of whether or not authorized maintenance task work is being performed in the datacenter.

In accordance with example implementations, the detected event includes a detected mismatch between an expected hash corresponding to program code of a computer platform and an observed hash of the program code. Determining whether the record authorizes the detected event includes determining that the record authorizes the observed hash. Among potential advantages, managing datacenter alarms based on pre-approved maintenance task alarm event records accurately detects physical security attacks, regardless of whether or not authorized maintenance task work is being performed in the datacenter.

In accordance with example implementations, the program code corresponds to at least one of firmware or software. Among potential advantages, managing datacenter alarms based on pre-approved maintenance task alarm event records accurately detects physical security attacks, regardless of whether or not authorized maintenance task work is being performed in the datacenter.

In accordance with example implementations, a given expected event corresponds to the detected mismatch, and the entry corresponding to the given expected event includes data to verify the observed hash. Among potential advantages, managing datacenter alarms based on pre-approved maintenance task alarm event records accurately detects physical security attacks, regardless of whether or not authorized maintenance task work is being performed in the datacenter.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated recorded items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
monitoring, by an alarm monitoring engine, a secure datacenter comprising computer platforms;
responsive to the monitoring, receiving, by the alarm monitoring engine, an alarm representing a detected event associated with the secure datacenter; and
responsive to the alarm, determining, by the alarm monitoring engine, whether the detected event complies with an approved maintenance task to be performed on a given computer platform of the computer platforms, wherein determining whether the detected event complies with the approved maintenance task comprises:
accessing a record corresponding to the approved maintenance task, wherein the record comprises entries corresponding to respective expected events associated with the approved maintenance task; and
determining whether the record authorizes the detected event; and
regulating whether the alarm is escalated responsive to the determination of whether the record authorizes the detected event.

2. The method of claim 1, wherein:
determining whether the record authorizes the detected event comprises determining whether the detected event corresponds to a given expected event of the expected events; and
regulating whether the alarm is escalated comprises suppressing the alarm responsive to determining that the detected event corresponds to the given expected event.

3. The method of claim 1, wherein:
the entries are ordered corresponding to an expected sequence for the expected events;
determining whether the record authorizes the detected event comprises determining whether an observed sequence associated with the detected event corresponds to the expected sequence; and
regulating whether the alarm is escalated comprises escalating the alarm responsive to determining that the observed sequence does not correspond to the expected sequence.

4. The method of claim 1, wherein:
the detected event comprises a detected opening of an access door of the secure datacenter; and
determining whether the record authorizes the detected event comprises determining whether the record authorizes a credential provided by a person associated with the detected opening.

5. The method of claim 1, wherein:
the detected event comprises a detected opening or closing of an access cover of a computer platform of the computer platforms; and
determining whether the record authorizes the detected event comprises determining whether the record authorizes the detected opening or closing of the access cover.

6. The method of claim 1, wherein:
the detected event comprises a detected powering on or off of a computer platform of the computer platforms; and
determining whether the record authorizes the detected event comprises determining whether the record authorizes the powering on or off.

7. The method of claim 1, wherein:
the detected event comprises a detected mismatch between an expected platform certificate for a computer platform of the computer platforms and an observed platform certificate of the computer platform; and
determining whether the record authorizes the detected event comprises determining whether the record authorizes the observed platform certificate.

8. The method of claim 7, wherein:
a given expected event of the expected events corresponds to the detected mismatch; and
the entry of the entries corresponding to the given expected event comprises data to verify the observed platform certificate.

9. The method of claim 1, wherein:
the detected event comprises a detected mismatch between an expected hash corresponding to program code of a computer platform of the computer platforms and an observed hash of the program code; and
determining whether the record authorizes the detected event comprises determining that the record authorizes the observed hash.

10. The method of claim 9, wherein the program code corresponds to at least one of firmware or software.

11. The method of claim 9, wherein:
a given expected event of the expected events corresponds to the detected mismatch; and
the entry of the entries corresponding to the given expected event comprises data to verify the observed hash.

12. A non-transitory storage medium that stores hardware processor-readable instructions to, when executed by a hardware processor, cause an alarm management engine to:
receive an observed alarm indicating an unexpected hash for a computer platform of a secure datacenter; and
responsive to the observed alarm:
access a record comprising data representing an expected sequence of alarm events for an approved maintenance task associated with the computer platform;
determine an expected hash based on the record and a platform certificate for the computer platform;
determine whether to escalate the observed alarm based on a comparison of the expected hash and the unexpected hash indicated by the alarm.

13. The storage medium of claim 12, wherein the instructions to, when executed by the hardware processor, further cause the alarm management engine to:
determine an observed history of the predetermined maintenance task; and
determine whether the observed alarm event is expected based on whether the observed alarm event is consistent with the observed history.

14. The storage medium of claim 12, wherein the instructions to, when executed by the hardware processor, further cause the alarm management engine to:
determine, based on the record, an identifier for a component of the computer platform to be replaced as part of the predetermined maintenance task;
determine whether the observed platform certificate is expected based on the identifier; and
determine whether to escalate the alarm based on the determination of whether the observed platform certificate is expected.

15. The storage medium of claim 12, wherein:
the observed platform certificate comprises a delta platform certificate; and
the alarm is received responsive to a security processor of the computer platform determining whether the delta platform certificate corresponds to an expected delta platform certificate for the computer platform.

16. The storage medium of claim 12, wherein:
the observed platform certificate indicates a manifest of one of multiple components of the computer platform.

17. A datacenter comprising:
computer platforms;
detectors to provide alarms indicating detected physical security attack events; and
an alarm monitoring engine coupled to the detectors and comprising a hardware processor to, responsive to a given alarm of the alarms:
access a record corresponding to an authorized maintenance task to be performed on a given computer platform of the computer platforms, wherein the record comprises entries corresponding to respective expected alarm events associated with the authorized maintenance task;
determine, based on the record and an observed maintenance task history, whether an alarm event corresponding to the given alarm is expected; and
regulate whether the given alarm is escalated responsive to the determination.

18. The datacenter of claim 17, wherein the hardware processor to further, responsive to the given alarm, determine that the alarm event is expected based on an entry of the record corresponding to the alarm event and the entry comprising data representing information associating the entry with the alarm event.

19. The datacenter of claim 17, wherein the hardware processor to further determine that the record is valid based on the observed maintenance task history.

20. The datacenter of claim 17, wherein the hardware processor to further, responsive to the given alarm, determine that the alarm event is unexpected based on the record containing an entry corresponding to the alarm event and the entry comprising data representing information that does not correspond to information about the alarm event.
